(19) United States
(12) Patent Application Publication
(10) Pub. No.: US 2017/0308763 A1
(43) Pub. Date: Oct. 26, 2017

(54) MULTI-MODALITY BIOMETRIC IDENTIFICATION

(71) Applicant: Microsoft Technology Licensing, LLC, Redmond, WA (US)

(72) Inventors: Eero Salmelin, Tampere (FI); Tommi Tavi, Tampere (FI)

(21) Appl. No.: 15/137,541

(22) Filed: Apr. 25, 2016

(51) Int. Cl. G06K 9/00; H04N 5/232; H04N 5/235; H04N 5/225

(52) U.S. Cl. CPC G06K 9/00892; H04N 5/2354; H04N 5/23212; H04N 5/2256; G06K 9/00033; G06K 9/00604; G06K 9/00255; G06K 9/00912

(57) ABSTRACT

An apparatus comprising an image sensor; an optical arrangement connected to the image sensor, defining an adjustable focus distance of the image sensor; and a process and control unit connected to the image sensor and the optical arrangement. The process and control unit is configured to obtain a biometric identifier request requesting detection of a biometric identifier which is a face, an iris, and a fingermark of a person, the face, eye, or fingertip of which, respectively, being present in a scene; adjust the focus distance of the image sensor on the basis of type of the requested biometric identifier; control the image sensor to capture at least one digital image frame of the face, eye, or fingertip; receive image data of the at least one digital image frame; and detect the biometric identifier on the basis of the received image data.

### BACKGROUND

Biometric identification methods based on, for example, detecting and recognizing a fingertip, a face, or iris of a person, may be used for various authentication or security purposes where the person is required to be identified. Apparatuses carrying out the detection and identification process may be implemented as a specific apparatus designed for biometric identification. Alternatively, equipment for biometric identification may be incorporated as a part of another type of apparatus or device such as, for example, a mobile or portable electronic device.

Versatility of an apparatus, as well as reliability of identification of a person and thus the security level of authentication, may be increased by an apparatus comprising equipment capable of carrying out biometric identification for several different biometric modalities. Complexity of such equipment may affect the usability thereof in some applications, such as in apparatuses with limited space and/or allowed production costs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An apparatus is disclosed which may be used for detecting one or more biometric identifiers such as an iris, a face, or fingermark of a person, for identification or authentication purposes. The apparatus may be a portable or mobile device, such as a mobile phone, a smart phone, a laptop computer, a tablet computer, a game controller, a game console, and a specific biometric identification device or apparatus.

The apparatus may comprise an image sensor; an optical arrangement connected to the image sensor, defining an adjustable focus distance and a viewing direction of the image sensor; and at least one process and control unit connected to the image sensor and the optical arrangement.

The at least one process and control unit may be configured to obtain a biometric identifier request requesting detection of a biometric identifier which is a face, an iris, and a fingermark of a person, the face, eye, or fingertip of which, respectively, is present in a scene; adjust the focus distance of the image sensor on the basis of type of the requested biometric identifier; control the image sensor to capture at least one digital image frame of the face, eye, or fingertip; receive image data of the at least one digital image frame; and detect the biometric identifier on the basis of the received image data.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIGS. 1 to 5 illustrate apparatuses and operation thereof for biometric identifier detection; and

FIGS. 6 and 7 illustrate methods for biometric identifier detection.

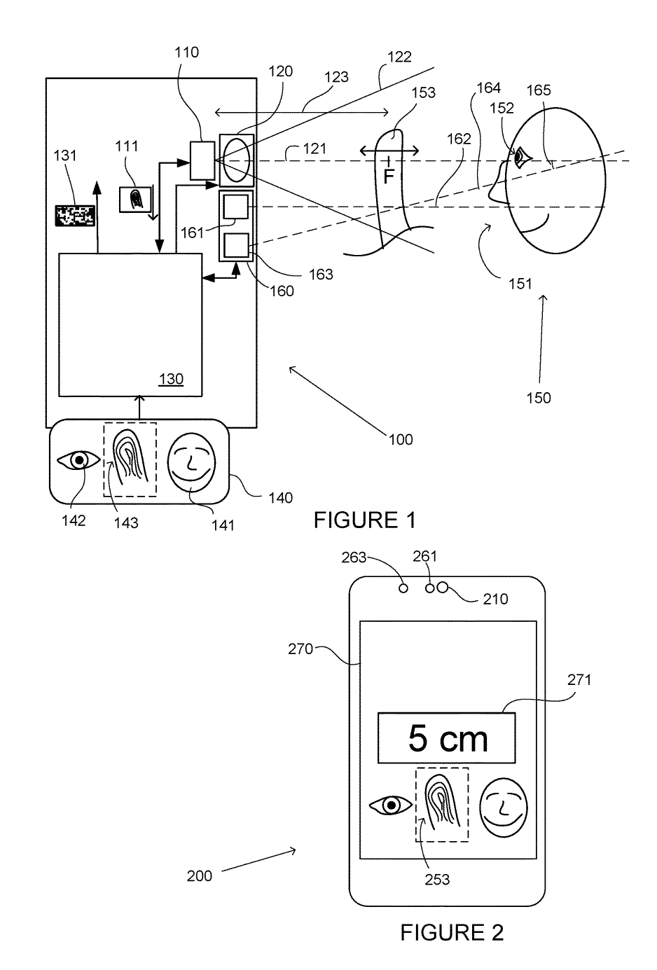

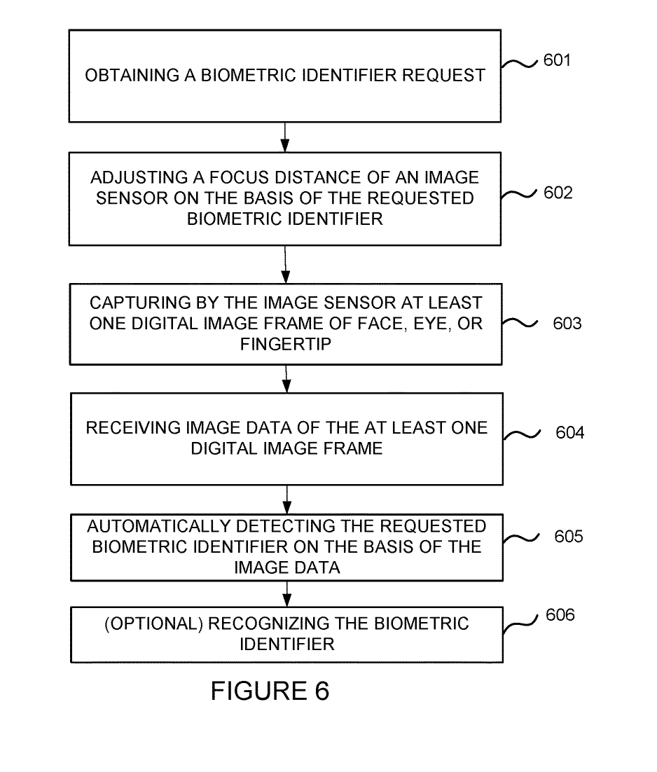

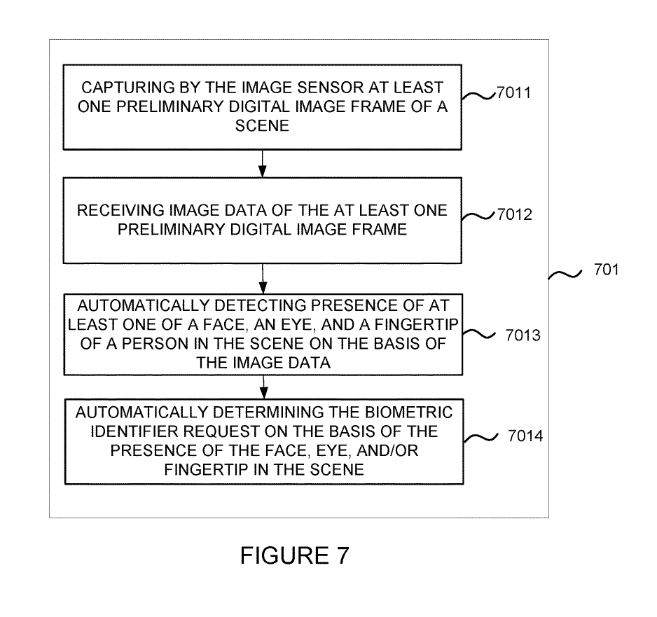

In FIGS. 1 and 3 to 5, the apparatuses are illustrated as schematic block diagrams. In FIG. 2, the apparatus is illustrated as a schematic front view. The methods of FIGS. 6 and 7 are illustrated as flow charts.

The drawings of the FIGS. 1 to 5 are not in scale.

### DETAILED DESCRIPTION

The detailed description provided below in connection with the appended drawings is intended as a description of a number of embodiments and is not intended to represent the only forms in which the embodiments may be constructed, implemented, or utilized.

The apparatus 100 of FIG. 1 comprises an image sensor 110, an optical arrangement 120 connected to the image sensor, and a process and control unit 130 connected to the image sensor and the optical arrangement.

An “image sensor” refers to a light sensitive component or element capable of capturing digital image frames of scenes shot by the image sensor. The image sensor may comprise, for example, a CMOS (Complementary Metal Oxide Semiconductor) or any other appropriate type of sensor element as an active, light detecting imaging element. The image sensor may be configured to operate in a rolling shutter mode. In some embodiments, it may be advantageously configured to operate in a global shutter mode.

A “digital image frame”, or shortly a “frame”, refers to a data content captured via exposure of pixels or some other light-sensing element(s) of an image sensor. A frame thus comprises image data enabling composition of a displayable digital image on the basis of that image data. Image data of a digital image may comprise, for example, information about light energy received by pixels of an image sensor.

The optical arrangement 120 is so configured, and so connected to the image sensor, that it defines a viewing direction 121 and a field of view 122 of the image sensor. A “viewing direction” refers to the central direction from which the image sensor captures light, or to which direction the image sensor can “see”. The viewing direction may also refer to the direction of an optical axis of the system formed by the image sensor and the optical arrangement.

The optical arrangement also defines the focus distance 123 of the image sensor. A “focus distance” refers to the distance of point F from the image sensor, from which distance a sharp, i.e. focused image is formed onto the image sensor.

The optical arrangement may comprise any appropriate lens assembly comprising one or more lenses and/or lens groups which may be of any appropriate type. At least one lens or lens group and/or the location thereof is adjustable so that the focus distance 123 may be changed. Also the field of view 122 of the image sensor may be adjustable by the optical arrangement. To move the location of one or more lenses or lens groups, for example, actuators comprising a voice coil motor or piezo actuators may be included in the optical arrangement. Further, any appropriate arrangements, elements, and operations as such known in various auto focus systems may be present in the optical arrangement and utilized for carrying out the adjustment of the focus distance.

Being connected to the image sensor and the optical arrangement refers to any appropriate operational connection arrangements allowing the process and control unit to control the operation of the image sensor and the optical arrangement, as well as to receive digital image frames captured by the image sensor, or the image data thereof, for processing the image data.

From a general point of view, the apparatus 100 may serve, when in use, for detecting one or more biometric identifiers of an eye, a face, and a fingermark of a person.

“Detecting” a biometric identifier refers to both detecting the presence of, and determining one or more such characteristic features of the biometric identifier at issue. Once being detected, such detected biometric identifier may further be used for recognizing the biometric identifier, the recognition referring to determining whether the detected biometric identifier is a particular existing biometric identifier, i.e. whether it belongs to a particular person. Recognizing a biometric identifier thereby serves for identifying the person, the biometric identifier of whom is being detected and recognized, i.e. confirming the identity of the person.

For example, recognizing an iris may comprise, for example, comparing one or more detected characteristic features of an iris with corresponding predetermined one or more characteristic features of an existing iris to determine whether the iris at issue is that particular existing iris belonging to an eye of a particular person, the identity of whom is known. Characteristic features of a plurality of existing irises may have been detected and/or determined and stored in a way enabling such comparison of the characteristic features of an iris under examination with characteristic features of a plurality of existing irises.

Recognizing a face or a face feature, in turn, may comprise, for example, comparing one or more detected characteristic features of a face or a specific face feature with corresponding predetermined one or more characteristic features of an existing face or one or more details thereof to determine whether the face at issue is that particular existing face. Characteristic features of a plurality of existing faces may have been detected and/or determined and stored in a way enabling such comparison of the characteristic features of a face under examination with characteristic features of a plurality of existing faces.

Recognizing a fingermark or a fingerprint may comprise, for example, comparing one or more detected characteristic features of a fingermark with corresponding predetermined one or more characteristic features of an existing fingermark to determine whether the fingermark at issue is that particular existing fingermark. Characteristic features of a plurality of existing fingermarks may have been detected and/or determined and stored in a way enabling such comparison of the characteristic features of a fingermark under examination with characteristic properties of a plurality of existing fingermarks.

From a more detail point of view, when in use, the process and control unit obtains a biometric identifier request 140 requesting detection of a biometric identifier of a person 150 who is present in a scene shot or viewed by the image sensor 110 so that at least a body part required to detect the requested biometric identifier is visible to the image sensor. For example, for a face 141 as the requested biometric identifier type, such body part is the face of the person. For an iris 142 as the requested biometric identifier type, at least an eye 152 of the person needs to be present in the scene and visible to the image sensor. For a fingermark 143 as the requested biometric identifier type, at least a fingertip 153 of the person shall be visible to the image sensor.

In the example illustrated in FIG. 1, the requested biometric identifier is a fingermark of the person 150 to be identified.

The request to detect a biometric identifier may be implemented in any appropriate signal or data form which the process and control unit may obtain and use for adapting the operation thereof accordingly.

“Obtaining” the biometric identifier request refers to any appropriate way of providing available or receiving the biometric identifier request. For example, the request may be ready generated by another unit or by another apparatus or device. Such ready generated request may be stored in any appropriate memory in the apparatus or in some other apparatus or device or, for example, in a cloud server.

A ready generated biometric identifier may be transmitted to and/or received by the process and control unit via any appropriate, wired or wireless data or signal transmission path.

Having obtained the biometric identifier request 140, the process and control unit 130 controls the optical arrangement 120 so as to adjust the focus distance of the image sensor on the basis of the type the requested biometric identifier. Further, the process and control unit controls the image sensor to capture one or more digital image frames images of the face, eye, or fingertip of the person, depending on the type of requested biometric identifier.

Adjusting the focus distance on the basis of the type of the requested biometric identifier refers to selecting the focus distance appropriately so that a sharp image is formed onto the image sensor from a predetermined appropriate distance, the sharp image allowing reliable biometric identifier detection on the basis if image data of digital image frame(s) captured by the image sensor.

Depending on the object to be imaged, i.e. depending on whether a digital image frame of face, eye, or fingertip is to be captured, there may be different appropriate or optimal focus distances. For example, for detecting a fingermark, a fingertip may be required to be positioned rather close to the image sensor in order to capture a sufficiently close view of the characteristic features of the fingermark. For detecting a face, for example, a significantly longer distance may be appropriate. The focus distance may be adjusted accordingly, i.e. in accordance with the appropriate distances of face, eye, and fingertip for face, iris, and fingermark detection, respectively.

The focus distance 123 may be adjustable, for example, in a range lying between and including 0.5 cm and 3 m. The appropriate focus distances for face, iris, and fingermark detection may be, for example, in the range of 40 cm to 3 m, in the range of 20 to 50 cm, and in the range of 0.5 to 15 cm, respectively. The focus distance may thus be adjustable, for example, from a minimum focus distance lying in the range of 0.5 to 15 cm to a maximum focus distance lying in the range of 40 to 300 cm.

To ensure a face, eye, or fingertip of the person lies at an appropriate distance from the image sensor, the apparatus may comprise any appropriate guiding arrangement to indicate to the person to be identified the requested biometric identifier and a target distance thereof from the apparatus or the image sensor thereof. Such guiding arrangement may ensure the person, or a body part of the person, lies at an appropriate position for reliable biometric identifier detection.

The apparatus 200 of FIG. 2, which may be generally in accordance with that discussed above with reference to FIG. 1, is implemented as a mobile device. In other embodiments, other types of apparatuses or devices may be used.

The apparatus 200 comprises a guiding arrangement comprising a display 270 displaying, when in use, the biometric identifier to be detected and the position to which the person should locate his/her fingertip, eye, or face. In the embodiment illustrated in FIG. 2, these indications are presented by simple graphical symbols of the biometric identifiers, the requested one being encircled by a rectangle, accompanied by the requested distance or the corresponding body part from the image sensor 210.

In the example illustrated in FIG. 2, the body part to be imaged is the fingertip 253 of the person.

First and second light sources 261, 263 of an illumination arrangement are marked in the drawing of FIG. 2 adjacent to the image sensor 210. The purpose and operation of such light sources are discussed below with reference to FIG. 1.

In other embodiments, a display may display, instead of or in addition to graphical symbols and the requested distance, the prevailing view of the image sensor. On the basis of the actual view seen by the image sensor, the person to be identified may adapt the position of the relevant body part relative to the apparatus appropriately.

In other embodiments, different guiding arrangements may be used comprising, in addition to or instead of graphic indicators such as those illustrated in FIG. 2, for example, voice instructing equipment and/or additional visual indicators which may indicate whether the person to be identified should re-position the relevant body part relative to the image sensor and the apparatus.

Referring back to FIG. 1, with the focus distance adjusted on the basis of the type of the requested biometric identifier, the process and control unit controls the images sensor 110 to capture one or more digital image frames 111 of the relevant body part. In the example illustrated in FIG. 2, the digital image frame is captured of the fingertip 153.

The process and control unit 130 receives at least a part of the image data of the digital image frame(s) 111, the at least part of the image data corresponding to the image area covered by the fingertip.

On the basis of the received image data, the process and control unit 130 detects the presence of and determines one or more such characteristic features of the fingermark on the basis of which the fingermark may be recognized.

In FIG. 1, the determined characteristic features of the fingertip are illustrated as being presented as QR (Quick Response) code 131. In other embodiments, the determined characteristic features of the biometric identifiers may be presented in any other appropriate way.

The process and control unit 130 may further carry out actual recognition of the biometric identifier, namely, the fingermark 143 in the example illustrated in FIG. 1. Alternatively, the actual recognition phase may be carried out by an external unit, device, or apparatus configured to obtain appropriate details of the biometric identifier detection carried out by the process and controlling unit 130 of the apparatus 100.

In the example procedure discussed above with reference to FIG. 1, the apparatus 100 serves for detecting one biometric identifier, namely, the fingermark 143.

In other embodiments, instead of one single biometric identifier, the apparatus may alternatively serve for detecting at least two biometric identifiers of a person. The process and control unit 130 may obtain a biometric identifier request requesting detection of any combination of two or three of a face, an iris, and a fingermark of a person to be identified. Consequently, it may control the optical arrangement 120 and the image sensor 110 to capture any appropriate number of digital image frames of appropriate body parts of the person to be identified. Similarly to the procedure discussed above, the process and control unit may receive image data of such digital image frame(s) and detect the requested two or more biometric identifiers on the basis of the received image data.

For a face and an iris as two requested biometric identifiers, it may be possible to detect both of those types of biometric identifier on the basis of image data of one or more digital image frames captured with one single common iris and face detection focus distance.

The adjustability of the focus distance may provide advantages in allowing detection of different biometric identifiers using one single image sensor and digital image frame(s) captured by it. For example, for each situation and application, the most appropriate biometric identifier may be detected using the same apparatus and the single image sensor thereof. Further, adjustable focus distance also allows detecting two or more biometric identifiers using said one single image sensor. Thereby, the level of authentication of a person to be identified may be increased without need for separate apparatuses or devices or image sensors for the different biometric identifiers.

In the example illustrated in FIG. 1, one single processing and control unit 130 is included in the apparatus 100. In other embodiments, an apparatus may comprise more than one processing and control units configured to serve for the control and processing operations. For example, an apparatus may comprise separate processing and control units. Further, there may be several units or sub-units configured to serve for the processing operations and/or several units or sub-units configured to serve for the controlling operations.

Any process and control unit or sub-unit may be a dedicated unit or sub-unit specifically designed for the above operations. Alternatively, it may be a general purpose unit of the apparatus also performing other operations and actions.

The apparatus 100 comprises also an illuminating arrangement 160 configured to illuminate the scene shot or viewed by the image sensor 110. The process and control unit 130 is connected to the illuminating arrangement to control it to illuminate the scene during capture of the digital image frame(s) by the image sensor.

The illumination arrangement comprises a first light source 161 configured to illuminate the scene from a first illumination direction 162, which may be substantially parallel to the viewing direction 121 of the image sensor, and a second light source 163 configured to illuminate the scene from a second, different illumination direction 164.

The second illumination direction 164 lies at an angle 165 of 4 to 10, for example, 6 to 8 degrees relative to the viewing direction of the image sensor. For capturing digital image frames for detection of different biometric identifiers, different light sources may be used. For example, the second light source may be used for illuminating an eye for detecting an iris of a person. The angle specified above may enable reliable detection of one or more characteristic features of an iris. The first light source may be used for detecting a face or a fingertip as the requested biometric identifier.

The light sources of the illumination arrangement 160 may comprise, for example, light emitting diodes LEDs or any other appropriate light emitting elements. The light sources may emit, when in use, infrared light. Then, the image sensor 110 may be configured to specifically detect, i.e. be sensitive to, infrared light at the same wavelength range.

Use of infrared light for illuminating the scene and capturing the digital image frame(s) may provide advantages in that the effect of ambient light in the captured digital image frame(s) may be minimized and the digital image frame(s) may be captured with well-defined illumination conditions. Moreover, infrared illumination light may be invisible for the person to be identified, which may provide a convenient user experience.

The light sources 161, 162 may be configured to or controlled to illuminate the scene with pulsed light, i.e. with sequential light pulses with limited duration.

In other embodiments, different configurations of illuminating arrangements may be used, comprising any appropriate number and type of light sources with any appropriate positioning.

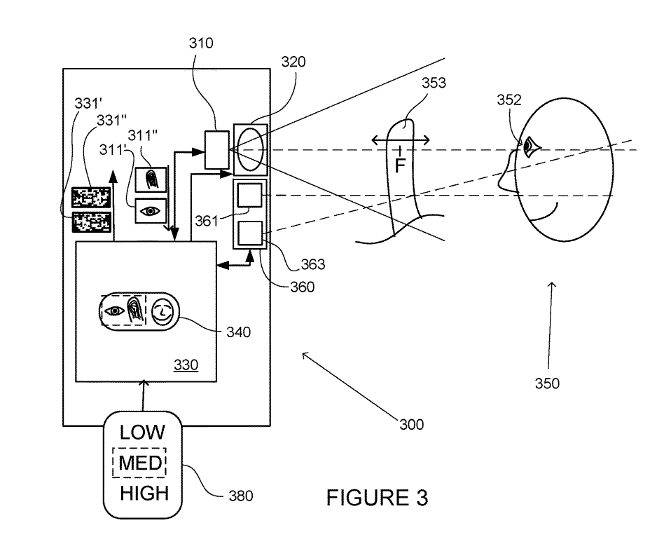

The apparatus 300 of FIG. 3 differs from that of FIG. 1 in that the process and control unit 330 thereof receives, when in use, instead of a ready determined biometric identification request, a requested authentication level 380 and determines a biometric identifier request 340 on the basis of the requested authentication level.

An “authentication level” refers to the reliability or security of authentication of a person. Higher authentication level refers to a higher probability that the authenticated person really is that one he/she is identified to be.

Different biometric identifiers, or biometric modalities, may enable different authentication levels. For example, higher authentication level may be achievable by recognizing an iris than by recognizing a face or a face feature of a person. Further, the authentication level may be increased by recognizing more than one biometric identifiers of a person. For example, two or more different biometric identifier types may be detected, such as a fingermark and an iris, or an iris and a face. Alternatively, more than one biometric identifiers of the same type may be detected, such as the irises of both eyes, or fingermarks of several fingers of a person.

A requested authentication level may be determined and provided, for example, by an application run on the apparatus and for which application the user of the apparatus has given an authentication or access request. Such application may be of any type where identification of the user may be important. Instead of a specific application, such authentication request may be initiated, for example, in response to the user's request or trial to get an access to the apparatus or to another apparatus or device connected to it.

Different access requests may relate to different required authentication levels. For example, just opening an apparatus or device such as a mobile device may require a first, lower level of authentication. Higher authentication level may then be required when the user tries to open some specific application requiring higher security, such as a mobile banking application. Generally, different operations may require different authentication levels also in a single apparatus or device.

In the example illustrated in FIG. 3, there are three possible authentication levels, namely, “LOW”, “MEDIUM”, and “HIGH”, MEDIUM being indicated as the requested one. Consequently, the process and control unit 330 has determined the biometric identifier request 340 to request detection of an iris and a fingermark of the person 350 to be identified.

Having determined the biometric identifier request 340, the process and control unit 330 operates, for detecting each of the iris and fingermark, generally in accordance with any of the embodiments discussed above with reference to FIGS. 1 and 2.

Thus, the process and control unit 330 controls the illumination arrangement 360 to illuminate the scene in which the person 350 is present by the second light source 363, and controls the optical arrangement 320 and the image sensor 310 to capture one more digital image frames 311′ of an eye 352 of the person. The process and control unit receives image data of the one or more digital image frames of the eye, and detects the presence of the iris and determines one or more characteristic features 331′ thereof on the basis of the received image data.

To detect the fingermark, the process and control unit 330 controls the illumination arrangement 360 to illuminate the scene in which the person 350 is present by the first light source 361, and controls the optical arrangement 320 and the image sensor 310 to capture one more digital image frames 311″ of a fingertip 353 of the person. The process and control unit receives image data of the one or more digital image frames of the fingertip, and detects the presence of the fingermark and determines one or more characteristic features 331″ thereof on the basis of the received image data.

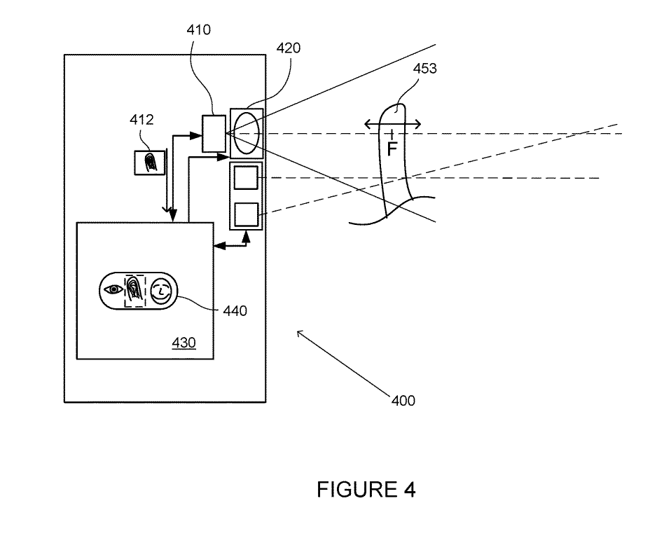

Yet another approach for obtaining a biometric identifier request is exemplified by the apparatus 400 of FIG. 4.

The process and control unit 430 of the apparatus 400 controls, when in use, the image sensor 410 to capture a preliminary digital image frame 412 of a scene, and receives image data of the preliminary digital image frame.

The process and signal unit then detects presence of a face, an eye, and/or a fingertip of a person in the scene on the basis of the received image data of the preliminary digital image frame 412. Detecting the presence refers to determining that a face, an eye, and/or a fingertip is present in scene and visible for the image sensor.

If no face, eye, or fingertip is found on the basis of the received image data of the preliminary digital image frame, further preliminary digital image frames, possibly with different focus distances and/or different fields of view, may be captured and the image data thereof may be analyzed.

When the process and control unit 430 detects presence of at least one of a face, an eye, and a fingermark, it determines a biometric identifier request 440 on the basis of the detected presence of the face, eye, and/or fingermark. The request may request detection of one or more biometric identifiers.

The process of detecting the presence of at least one or more of a face, an eye, and a fingertip allows determination what kind of biometric modalities are available for biometric identification and recognition purposes. On the basis of such detection, the process and control unit may determine an appropriate biometric identifier request.

In the example illustrated in FIG. 4, there is a fingertip 453 visible in the preliminary image frame 412. The process and control unit has determined on the basis thereof the biometric identifier request 440 to request detection of a fingermark.

In other examples or embodiments, a process and control unit may determine the biometric identifier request on the basis of both detected presence of the face, eye, and/or fingermark, and a requested authentication level. Thus, those two criteria may be simultaneously taken into account in determining the biometric identifier request.

Having determined the biometric identifier request, the apparatus may operate in accordance with any of the embodiments discussed above with reference to FIGS. 1 to 3.

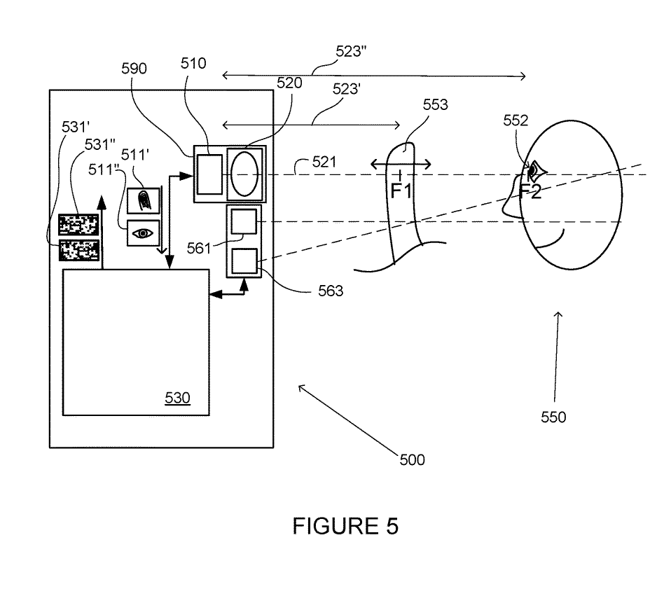

The apparatus 500 of FIG. 5 differs from that of FIG. 1 in that the image sensor 510 and the optical arrangement 520 are incorporated into an integral imaging module 590 having a an adjustable focus distance 523 and a viewing direction 521. The process and control unit 530 is connected to the imaging module to control it and to receive image data of digital image frames captured by the imaging module.

From an operational point of view, the apparatus 500 may operate, when in use, generally in accordance with any of those of FIGS. 1 to 4. For example, the apparatus is capable of capturing, by the imaging module 590, a first digital image frame 511′ of a first body part such as a fingertip 553 of a person 550, positioned at a first distance F1 from the apparatus, with the focus distance 523′ adjusted according to the first distance, while illuminating the first body part by the first light source 161.

The apparatus 500 is further capable of capturing, by the imaging module 590, a second digital image frame 511″of a second body part which is different from the first body part, such as an eye 552 of the person, positioned at a second distance F2 from the apparatus, with the focus distance 523″ adjusted according to the second distance which is different from the first distance, while illuminating the second body part by the second light source 563.

Further, the apparatus is capable of, by the process and control unit 530, receiving image data of at least one digital image frame of each of the first and the second digital image frames 511′, 511″, and detecting, on the basis of the received image data, at least one characteristic feature of the first body part and the second body part of the person 531′, 531″.

The apparatus 500 may be further capable of detecting any other combination of two or three of a fingermark, an iris, and a face as biometric identifiers.

In the apparatuses discussed above with reference to FIGS. 1 to 5, with regard to the operations carried out by the one or more process and control units, there are various possibilities for the process and control units to be configured to perform those operations. For example, a process and/or control unit or sub-unit may comprise at least one processor and at least one memory coupled to the at least one processor, the memory storing program code instructions which, when run on the at least one processor, cause the processor to perform the operations action(s) at issue.

Alternatively, or additionally, the functionally described features can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any of the apparatuses discussed above may be a specific apparatus or device specifically designed for biometric identifier detection. Alternatively, an apparatus may be configured to serve for other purposes also. In both cases, the apparatus may be implemented as, or incorporated in, various types of access control apparatuses or systems controlling access of persons through a door, gate, or some specific access point.

In addition to actual physical access control, such apparatus may be implemented as, or incorporated in, an electronic apparatus, device, or system, such as a personal computer, where biometric identifier detection may be used for user identification to control access to the apparatus, device, or system, or to an application run on such apparatus, device, or system. Other examples of such electronic devices and systems comprise, for example, cash dispensers, automated teller machines, and various types of electronic payment terminals. Such device may also be a portable or mobile device, such as a laptop computer, a tablet computer, a mobile phone, or a smartphone, without being limited to these examples. In general, the apparatus, device, or system in which the biometric identifier detection equipment are incorporated and in which the biometric identifier detection method are carried out may be an any type of apparatus, device, or system where biometric identifier detection may be used, for example, for identification or authentication purposes.

The methods discussed below with reference to FIGS. 6 and 7 may be carried out by apparatuses generally in accordance with those of FIGS. 1 to 5. The apparatuses of FIGS. 1 to 5, in turn, may operate generally in accordance with the methods of FIGS. 6 and 7.

The advantages discussed above with reference to FIGS. 1 to 5 apply, mutatis mutandis, also to the methods discussed below with reference to FIGS. 6 and 7.

The method of FIG. 6 starts by obtaining, in operation 601, a biometric identifier request requesting detection of a biometric identifier which may be a face, an iris, and a fingermark of a person, the face, eye, or fingertip of which, respectively, is present in a scene shot by an image sensor.

In operation, 602, focus distance of the image sensor is adjusted on the basis of type of the requested biometric identifier. Any appropriate equipment and operations as such known in various auto focus systems may be utilized to carry out the adjustment of the focus distance.

In operation 603, one or more digital image frames of the face, eye, or fingertip is captured by the image sensor.

Image data of the at least one digital image frame is received in operation 604, and in operation 605, the requested biometric identifier is automatically detected on the basis of the received image data.

Concerning the details of the method, the equipment used to carry out the operations thereof, as well as possible variations of the basic process in different embodiments may be in accordance with the operation of any of the apparatuses discussed above with reference to FIGS. 1 to 5.

For example, a biometric identifier request may be received which requests detection of more than one biometric identifier. Then, the operations of the method of FIG. 6 may be carried out for each of the requested biometric identifier type.

As another example of possible further features of the method, the scene may be illuminated in accordance with any of the illumination schemes discussed above with reference to FIGS. 1 to 5.

As discussed above with reference to FIGS. 3 and 4, obtaining a biometric identifier request may comprise receiving a requested authentication level, and automatically determining the biometric identifier request on the basis of the requested authentication level.

Another example is illustrated in FIG. 7, which is based on seeking whether a face, an eye, or a fingertip of the person to be identified is available for imaging, and determining the biometric identifier request on the basis of the presence of one or more of those body parts in the scene, visible to the image sensor.

The operation 701 of obtaining a biometric identifier request of FIG. 7 starts by capturing, in sub-operation 7011, one or more preliminary digital image frames of the scene by the image sensor. Image data of the captured preliminary digital image frame(s) is then received in sub-operation 7012.

On the basis of the received image data, presence of at least one of a face, an eye, and a fingertip of the person to be identified in the scene is automatically detected in sub-operation 7013.

On the basis of the found body part(s), the biometric identifier is automatically determined in sub-operation 7014.

The details of the operation 701 may be, for example, in accordance with any of the embodiments discussed above with reference to FIG. 4.

“Automatically” performing one or more operations refers to performing the operation(s) at issue, for example, detecting a biometric identifier, by one or more appropriate data processing units or modules, such as the process and control units discussed above with reference to FIGS. 1 to 5, according to predetermined rules and procedures, without need for any contribution provided or determination performed by a user of an apparatus or device incorporating such unit or module. In addition to those operations specifically stated to be performed automatically, also other operations may be carried completely or partially automatically.

Some component, device, module, unit, or element “being configured to” operate in a specific manner or to carry out specific operations, or carrying out such operations when in use, refers to that component, device, module, unit, or element comprising, or itself serving as, “means for” operating in that manner or carrying out those operations.

For example, a process and control which is configured to obtain a biometric identifier request; adjust the focus distance of the image sensor; control the image sensor to capture at least one digital image frame; receive image data of the at least one digital image frame; and detect the biometric identifier means that said process and control unit comprise, or serve as, means for obtaining a biometric identifier request; adjusting the focus distance of the image sensor; controlling the image sensor to capture at least one digital image frame; receiving image data of the at least one digital image frame; and detecting the biometric identifier. As another example, a light source emitting, when in use, infrared light, comprise, or serve as, means for emitting infrared light.

Some embodiments are further discussed shortly in the following.

In a first aspect, an apparatus comprises an image sensor; an optical arrangement connected to the image sensor, defining an adjustable focus distance and a viewing direction of the image sensor; and at least one process and control unit connected to the image sensor and the optical arrangement. The at least one process and control unit is configured to obtain a biometric identifier request requesting detection of a biometric identifier which is a face, an iris, and a fingermark of a person, the face, eye, or fingertip of which, respectively, being present in a scene; adjust the focus distance of the image sensor on the basis of type of the requested biometric identifier; control the image sensor to capture at least one digital image frame of the face, eye, or fingertip; receive image data of the at least one digital image frame; and detect the biometric identifier on the basis of the received image data.

From an alternative point of view, an apparatus may comprise an image sensor; means for defining an adjustable focus distance and a viewing direction of the image sensor; and process and control means for obtaining a biometric identifier request requesting detection of a biometric identifier which is a face, an iris, and a fingermark of a person, the face, eye, or fingertip of which, respectively, being present in a scene; adjusting the focus distance on the basis of type of the requested biometric identifier; controlling the image sensor to capture at least one digital image frame of the face, eye, or fingertip; receiving image data of the at least one digital image frame; and detecting the biometric identifier on the basis of the received image data.

In an embodiment, the focus distance is adjustable from a minimum focus distance lying in the range of 0.5 to 15 cm to a maximum focus distance lying in the range of 40 to 300 cm.

In an embodiment, which may be in accordance with the previous embodiment, the apparatus further comprises a guiding arrangement configured to indicate the requested biometric identifier and a target position thereof relative to the apparatus. From the alternative point of view, the apparatus may further comprise guiding means for indicating the requested biometric identifier and a target position thereof relative to the apparatus.

In an embodiment, which may be in accordance with any of the previous embodiments, the apparatus comprises an illuminating arrangement comprising a first light source configured to illuminate the scene from a first illumination direction; and a second light source configured to illuminate the scene from a second illumination direction different from the first illumination direction; the at least one process and control unit being connected to the illuminating arrangement and being configured to control the illuminating arrangement to illuminate the scene during capture of the digital image frame by at least one of the first and the second light sources. From the alternative point of view, the apparatus may comprise illuminating means for illuminating the scene from a first illumination direction; and illuminating the scene from a second illumination direction different from the first illumination direction; for illuminating the scene during capture of the digital image frame from at least one of the first and the second illuminating directions.

In an embodiment in accordance with the previous embodiment, the second illumination direction lies at an angle of 4 to 10 degrees, for example, 6 to 8 degrees relative to the viewing direction of the image sensor.

In an embodiment in accordance with any of the two preceding embodiments, the first and the second light sources are configured to illuminate the scene by, and the image sensor is configured to detect, infrared light. From the alternative point of view, the illuminating means may comprise, or serve as, means for illuminating the scene by infrared light, and the image sensor may be configured to detect infrared light.

In an embodiment in accordance with any of the three preceding embodiments, the first and the second light sources are configured to illuminate the scene with pulsed light. From the alternative point of view, the illuminating means may comprise, or serve as, means for illuminate the scene with pulsed light.

In an embodiment, which may be in accordance with any of the previous embodiments, to obtain the biometric identifier request, the at least one process and control unit is configured to obtain a requested authentication level; and determine the biometric identifier request on the basis of the requested authentication level. From the alternative point of view, the process and control means may comprise, or serve as, means for obtaining a requested authentication level; and determining the biometric identifier request on the basis of the requested authentication level.

In an embodiment, which may be in accordance with any of the previous embodiments, to obtain the biometric identifier request, the at least one process unit is configured to control the image sensor to capture at least one preliminary digital image frame of the scene; receive image data of the at least one preliminary digital image frame; detect presence of a face, an eye, and/or a fingertip of a person in the scene on the basis of the received image data of the preliminary digital image frames; and determine the biometric identifier request on the basis of the presence of the face, eye, and/or a fingertip of a person present in the scene. From the alternative point of view, the process and control means may comprise, or serve as, means for controlling the image sensor to capture at least one preliminary digital image frame of the scene; receiving image data of the at least one preliminary digital image frame; detecting presence of a face, an eye, and/or a fingertip of a person in the scene on the basis of the received image data of the preliminary digital image frames; and determining the biometric identifier request on the basis of the presence of the face, eye, and/or a fingertip of a person present in the scene.

In an embodiment, which may be in accordance with any of the previous embodiments, the biometric identifier request requests detection of at least two biometric identifiers of a face, an iris, and a fingermark of the person; and the at least one process and control unit is, for each type of the requested biometric identifier, configured to adjust the focus distance on the basis of type of the requested biometric identifier; control the image sensor to capture at least one digital image frame of the face, eye, or fingertip; and receive image data of the at least one digital image frame and detect the requested biometric identifier on the basis of the received image data. From the alternative point of view, the biometric identifier request requests detection of at least two biometric identifiers of a face, an iris, and a fingermark of the person; and the process and control means comprise, or serve as, for each type of the requested biometric identifier, means for adjusting the focus distance on the basis of type of the requested biometric identifier; controlling the image sensor to capture at least one digital image frame of the face, eye, or fingertip; and receiving image data of the at least one digital image frame and detect the requested biometric identifier on the basis of the received image data.

In an alternative embodiment, which may be in accordance with any of the embodiments preceding the previous one, the biometric identifier request requests detection of a face and an iris of the person; and the at least one process and control unit is configured to adjust the focus distance to a predetermined common iris and face detection focus distance; control the image sensor to capture at least one digital image frame of the face; and receive image data of the at least one digital image frame, and detect the face and the iris of the person on the basis of the received image data. From the alternative point of view, the biometric identifier request requests detection of a face and an iris of the person; and the process and control means comprise, or serve as, means for adjusting the focus distance to a predetermined common iris and face detection focus distance; controlling the image sensor to capture at least one digital image frame of the face; and receiving image data of the at least one digital image frame and detecting the face and the iris of the person on the basis of the received image data.

In a second aspect, an apparatus comprises an imaging module having an adjustable focus distance and a viewing direction; at least one light source; and at least one process unit connected to the imaging module to receive image data of digital image frames captured by the imaging module. The apparatus is capable of capturing, by the imaging module, a first digital image frame of a first body part which is a face, an eye, and a fingertip of a person, positioned at a first distance from the apparatus, with the focus distance adjusted according to the first distance, while illuminating the first body part by a light source of the at least one light sources; capture, by the imaging module, a second digital image frame of a second body part which is different from the first body part and is a face, an eye, and a fingertip of the person, positioned at a second distance from the apparatus, with the focus distance adjusted according to the second distance which is different from the first distance, while illuminating the second body part by a light source of the at least one light sources; and by the process unit, receive image data of at least one of the first and the second digital image frames, and detect, on the basis of the received image data, at least one characteristic feature of at least two of fingermark, iris, and face of the person.

In an embodiment, the first distance is in the range of 0.5 to 15 cm, for example, 5 cm, and the second distance is in the range of 20 to 50 cm, for example, 30 cm.

In a third aspect, a method comprises obtaining a biometric identifier request requesting detection of a biometric identifier which is a face, an iris, and a fingermark of a person, the face, eye, or fingertip of which, respectively, being present in a scene; adjusting a focus distance of an image sensor having a viewing direction on the basis of type of the requested biometric identifier; capturing by the image sensor at least one digital image frame of the face, eye, or fingertip; receiving image data of the at least one digital image frame; and automatically detecting the biometric identifier on the basis of the received image data.

In an embodiment, the focus distance is adjusted to a distance in the range of 0.5 to 300 cm.

In an embodiment, which may be in accordance with the previous embodiment, the method comprises indicating the requested biometric identifier and a target position thereof relative to the apparatus.

In an embodiment, which may be in accordance with any of the previous embodiments of the third aspect, the method comprises illuminating the scene during capture of the at least one digital image frames.

In an embodiment in accordance with the previous embodiment, the biometric identifier request requests detection of an iris, and the scene is illuminated during capture of the at least one digital image frame from a direction lying at an angle of 4 to 10, for example, 6 to 8 degrees relative to the viewing direction of the image sensor.

In an embodiment in accordance with any of the two preceding embodiments of the third aspect, the scene is illuminated by, and the digital image is captured by receiving, infrared light.

In an embodiment, which may be in accordance with any of the previous embodiments of the third aspect, obtaining the biometric identifier request comprises receiving a requested authentication level; and automatically determining the biometric identifier request on the basis of the requested authentication level.

In an embodiment, which may be in accordance with any of the previous embodiments of the third aspect, obtaining the biometric identifier request comprises capturing by the image sensor at least one preliminary digital image frame of the scene; receiving image data of the at least one preliminary digital image frame; automatically detecting presence of a face, an eye, and/or a fingertip of a person in the scene on the basis of the received image data of the preliminary digital image frames; and automatically determining the biometric identifier request on the basis of the presence of the face, eye, and/or a fingertip of a person present in the scene.

In an embodiment, which may be in accordance with any of the previous embodiments of the third aspect, the biometric identifier request requests detection of at least two biometric identifiers of a face, an iris, and a fingermark of the person, and the method comprises, for each type of the requested biometric identifier, adjusting the focus distance on the basis of type of the requested biometric identifier; controlling the image sensor to capture at least one digital image frame of the face, eye, or fingertip; and receiving image data of the at least one digital image frame and detecting the requested biometric identifier on the basis of the received image data.

In an alternative embodiment, which may be in accordance with any of the embodiments of the third aspect preceding the previous one, the biometric identifier request requests detection of a face and an iris of the person, and the method comprises adjusting the focus distance to a predetermined common iris and face detection focus distance; controlling the image sensor to capture at least one digital image frame of the face; and receiving image data of the at least one digital image frame and detecting the face and the iris of the person on the basis of the received image data.

Although some of the present embodiments may be described and illustrated as being implemented in a smartphone, a mobile phone, or a tablet computer, these are only examples of a device and not a limitation. As those skilled in the art will appreciate, the present embodiments are suitable for application in a variety of different types of devices, such as portable and mobile devices, for example, in lap upper computers, tablet computers, game consoles or game controllers, various wearable devices, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

1. An apparatus comprising
an image sensor;
an optical arrangement connected to the image sensor, the optical arrangement defining an adjustable focus distance and a viewing direction of the image sensor; and
at least one process and control unit connected to the image sensor and the optical arrangement;
the at least one process and control unit being configured to:
obtain a biometric identifier request requesting detection of a biometric identifier which is a face, an iris, and a fingermark of a person, the face, eye, or fingertip of which, respectively, being present in a scene;
adjust the focus distance of the image sensor on the basis of type of the requested biometric identifier;
control the image sensor to capture at least one digital image frame of the face, eye, or fingertip;
receive image data of the at least one digital image frame; and
detect the biometric identifier on the basis of the received image data.

2. An apparatus as defined in claim 1, wherein the focus distance is adjustable from a minimum focus distance lying in the range of 0.5 to 15 cm to a maximum focus distance lying in the range of 40 to 300 cm.

3. An apparatus as defined in claim 1, further comprising a guiding arrangement configured to indicate the requested biometric identifier and a target position thereof relative to the apparatus.

4. An apparatus as defined in claim 1, comprising an illuminating arrangement comprising
a first light source configured to illuminate the scene from a first illumination direction; and
a second light source configured to illuminate the scene from a second illumination direction different from the first illumination direction;
the at least one process and control unit being connected to the illuminating arrangement and being configured to control the illuminating arrangement to illuminate the scene during capture of the digital image frame by at least one of the first and the second light sources.

5. An apparatus as defined in claim 4, wherein the second illumination direction lies at an angle of 4 to 10 degrees, for example, 6 to 8 degrees relative to the viewing direction of the image sensor.

6. An apparatus as defined in claim 4, wherein the first and the second light sources are configured to illuminate the scene by, and the image sensor is configured to detect, infrared light.

7. An apparatus as defined in claim 1, wherein, to obtain the biometric identifier request, the at least one process and control unit is configured to obtain a requested authentication level; and determine the biometric identifier request on the basis of the requested authentication level.

8. An apparatus as defined in claim 1, wherein, to obtain the biometric identifier request, the at least one process unit is configured to
control the image sensor to capture at least one preliminary digital image frame of the scene;
receive image data of the at least one preliminary digital image frame;
detect presence of a face, an eye, and/or a fingertip of a person in the scene on the basis of the received image data of the preliminary digital image frames; and
determine the biometric identifier request on the basis of the presence of the face, eye, and/or a fingertip of a person present in the scene.

9. An apparatus as defined in claim 1, wherein the biometric identifier request requests detection of at least two biometric identifiers of a face, an iris, and a fingermark of the person; and the at least one process and control unit is, for each type of the requested biometric identifier, configured to
adjust the focus distance on the basis of type of the requested biometric identifier;
control the image sensor to capture at least one digital image frame of the face, eye, or fingertip; and
receive image data of the at least one digital image frame and detect the requested biometric identifier on the basis of the received image data.

10. An apparatus as defined in claim 1, wherein the biometric identifier request requests detection of a face and an iris of the person; and the at least one process and control unit is configured to
adjust the focus distance to a predetermined common iris and face detection focus distance;
control the image sensor to capture at least one digital image frame of the face; and
receive image data of the at least one digital image frame and detect the face and the iris of the person on the basis of the received image data.

11. An apparatus comprising
an imaging module having an adjustable focus distance and a viewing direction;
at least one light source; and
at least one process unit connected to the imaging module to receive image data of digital image frames captured by the imaging module;
the apparatus being capable of
capturing, by the imaging module, a first digital image frame of a first body part which is a face, an eye, and a fingertip of a person, positioned at a first distance from the apparatus, with the focus distance adjusted according to the first distance, while illuminating the first body part by a light source of the at least one light sources;
capturing, by the imaging module, a second digital image frame of a second body part which is different from the first body part and is a face, an eye, and a fingertip of the person, positioned at a second distance from the apparatus, with the focus distance adjusted according to the second distance which is different from the first distance, while illuminating the second body part by a light source of the at least one light sources; and
by the process unit, receiving image data of at least one of the first and the second digital image frames, and detecting, on the basis of the received image data, at least one characteristic feature of at least two of fingermark, iris, and face of the person.

12. An apparatus as defined in claim 11, wherein the first distance is in the range of 0.5 to 15 cm, for example, 5 cm, and the second distance is in the range of 20 to 50 cm, for example, 30 cm.

13. A method comprising
obtaining a biometric identifier request requesting detection of a biometric identifier which is a face, an iris, and a fingermark of a person, the face, eye, or fingertip of which, respectively, being present in a scene;
adjusting a focus distance of an image sensor having a viewing direction on the basis of type of the requested biometric identifier;
capturing by the image sensor at least one digital image frame of the face, eye, or fingertip;
receiving image data of the at least one digital image frame; and
automatically detecting the biometric identifier on the basis of the received image data.

14. A method as defined in claim 13, wherein the focus distance is adjusted to a distance in the range of 0.5 to 300 cm.

15. A method as defined in claim 13, comprising indicating the requested biometric identifier and a target position thereof relative to the apparatus.

16. A method as defined in claim 13, comprising illuminating the scene during capture of the at least one digital image frames. 17 A method as defined in claim 16, wherein the biometric identifier request requests detection of an iris, and the scene is illuminated during capture of the at least one digital image frame from a direction lying at an angle of 4 to 10, for example, 6 to 8 degrees relative to the viewing direction of the image sensor.

18. A method as defined in claim 16, wherein the scene is illuminated by, and the digital image is captured by receiving, infrared light.

19. A method as defined in claim 13, wherein obtaining the biometric identifier request comprises receiving a requested authentication level; and automatically determining the biometric identifier request on the basis of the requested authentication level.

20. A method as defined in claim 13, wherein obtaining the biometric identifier request comprises
capturing by the image sensor at least one preliminary digital image frame of the scene;
receiving image data of the at least one preliminary digital image frame;
automatically detecting presence of a face, an eye, and/or a fingertip of a person in the scene on the basis of the received image data of the preliminary digital image frames; and
automatically determining the biometric identifier request on the basis of the presence of the face, eye, and/or a fingertip of a person present in the scene.
